(19) United States
(12) Patent Application Publication
(10) Pub. No.: US 2008/0215519 A1
(43) Pub. Date: Sep. 4, 2008

(54) METHOD AND DATA PROCESSING SYSTEM FOR THE CONTROLLED QUERY OF STRUCTURED SAVED INFORMATION

(75) Inventors: Fred Runge, Wuensdorf (DE); Felix Burkhardt, Berlin (DE); Jin Liu, Berlin (DE); Christel Mueller, Schulzendorf (DE)

Correspondence Address: DARBY & DARBY P.C., P.O. BOX 770, Church Street Station, New York, NY, 10008-0770, US

(73) Assignee: DEUTSCHE TELEKOM AG, Bonn (DE)

(21) Appl. No.: 12/014,886

(22) Filed: Jan. 16, 2008

(30) Foreign Application Priority Data
Jan. 25, 2007 (DE) 10 2007 004 684.9

(51) Int. Cl. G06N 5/02; G06F 17/30; G06F 7/10; G06F 17/28

(52) U.S. Cl. 706/47; 707/4; 704/8; 707/E17.017

(57) ABSTRACT

A method for the controlled querying of information stored in a structured format in a data processing system using a dialog system includes: providing at least one first ontology configured to store information in a structured format; and providing at least one input grammar in the dialog system configured to analyze user inputs as a function of the at least one first ontology.

### CROSS-REFERENCE TO RELATED APPLICATIONS

This application claims benefit to German Patent Application No. 10 2007 004 684.9 filed Jan. 25, 2007.

### FIELD

The present invention relates to a method and to a data processing system for the controlled querying of information stored in a structured format using a dialog system.

### BACKGROUND

In recent years, it has become a customary practice to use the term “ontology” in information technology, particularly in the field of knowledge management. The concept of ontology, which is originally derived from the field of philosophy, generally describes the explicit and formal-language specification of a conceptualization of phenomena in a slice of reality that is jointly used by a plurality of actors. In information technology, the actors typically include people and machines. A communication between man and machine requires that both use a shared vocabulary. This can be achieved with the aid of ontologies.

Accordingly, the attempt is made to use ontologies to represent at least one segment of the real world. The relationships and interrelationships among objects are analyzed and combined into one vocabulary that can be used for representing and storing knowledge, and for generating new knowledge using the appropriate mechanisms.

Thus, an ontology typically includes an object model in the form of a hierarchical class structure that is used for structuring data. In this connection, classes are collections of similar types of objects, commonly known as instances, in one representation or implementation unit. Accordingly, individual experiential objects, entities or individuals that are combined to form one class as a unit of thought, are termed instances. Besides classes and instances thereof, an ontology typically includes relationships among objects and the properties or attributes of objects.

Thus, an ontology describes a general vocabulary in a field of knowledge, also termed knowledge domain, and the meaning of individual units in this vocabulary, and thus a common basis for a shared understanding for man and machine.

To access the information contained in an ontology, dialog systems are known which are used for the linguistic- and analog-based multimodal interaction with at least one user. The German Patent Application DE 103 18 333 A1, for example, describes voice dialog systems that are used for the voice-controlled querying of ontologies.

Methods are likewise known for extracting ontologies from monolingual written texts using sets of extraction rules, documents advantageously being searched for that reflect the domain knowledge required for creating the ontology. To that end, for existing reference documents, known methods can be used to search for similar documents.

The general design of dialog systems used for the linguistic- and analog-based multimodal interaction with at least one user is known, for example, from the working draft of the World Wide Web Consortium (W3C) “Introduction and Overview of W3C Speech Interface Framework” (W3C working draft of Dec. 4, 2000).

In the systems which include a dialog system, it is typically provided for a user to query the system and receive responses in accordance with the knowledge base that exists, for example, in the form of an ontology having corresponding specific instances. To derive the responses, an inference engine can also be used, as described, for example, in the International Patent Application WO 2005/055134 A2.

The grammar used in these systems for describing possible user inputs is typically predefined by a system administrator. This requires considerable time and effort on the part of the system administrator and, at the same time, does not offer much flexibility.

### SUMMARY

An aspect of the present invention is to provide an improved method for querying information that has been stored in a hierarchical structure with the aid of an ontology.

A further, alternative, aspect of the present invention is to provide an improved method for expanding and/or correcting ontologies.

In an embodiment, the present invention provides a method for the controlled querying of information stored in a structured format in a data processing system using a dialog system. The method includes: providing at least one first ontology configured to store information in a structured format; and providing at least one input grammar in the dialog system configured to analyze user inputs as a function of the first ontology.

### BRIEF DESCRIPTION OF THE DRAWINGS

Aspects of the present invention will now be described by way of exemplary embodiments with reference to the following drawing, in which:

FIG. 1 shows a schematic representation of a preferred embodiment of a data processing system according to the present invention;

FIG. 2 shows a schematic representation of elements of an exemplary ontology according to an exemplary embodiment of the present invention;

FIG. 3 illustrates an example for expanding the ontology from FIG. 2; and

FIG. 4 illustrates an example of an ontology containing linguistic properties as elements according to an exemplary embodiment of the present invention.

### DETAILED DESCRIPTION

A method according to an aspect of the present invention provides for the controlled querying of information stored in a structured format in a data processing system, using a dialog system, provides for a first ontology for storing information in a structured format and for at least one input grammar in the dialog system for analyzing user inputs as a function of the first ontology.

As already described above, an ontology typically includes an object model in the form of a hierarchical class structure that is used for structuring data. Accordingly, the first ontology advantageously includes a hierarchical class structure having classes, instances of classes, relationships among classes and/or attributes.

A grammar denotes a structured description of possible inputs to be analyzed entered by a user or by the data processing system itself. Examples of possible user inputs include spoken language, text inputs, inputs entered via a touch screen using a stylus, or facial expressions of a user captured by a camera. Inputs provided by the system include text character strings in documents, recorded voice or multimedia data files, for example. A grammar represents a form of a media model and preferably includes a model for describing the sequence in which inputs, such as words from a media recognition device, such as a voice recognition device, are expected, and/or in which outputs having specific informational contents are generated. A grammar may advantageously be specially designed as an input or output grammar.

In one embodiment of the method, the provision of the at least one input grammar includes generating the input grammar from the first ontology as a function of predefined generation rules. Alternatively, an initial grammar is predefined as a first draft of an input grammar that is manually created by a system administrator, for example. This initial grammar is then preferably expanded and/or corrected as a function of the first ontology and predefined expansion and/or correction rules.

It is beneficial that the method includes the expansion of the first ontology. Accordingly, an input grammar generated as a base grammar from the first ontology as a function of predefined generation rules is also advantageously expanded and/or corrected as a function of the first ontology and of predefined expansion and/or correction rules, when, for example, the first ontology, for its part, had been expanded and/or modified.

One variant for expanding the first ontology provides for information to be obtained from files and/or second ontologies using search and/or extraction rules and for the first ontology to be expanded to include this information. The first ontology may also be advantageously expanded by inserting references to at least one file and/or to a second ontology and/or to an element of a second ontology. Such a reference may include a file path, an Internet address or another address of a storage location, for example, and optionally additional parameters. In addition, the provision of the first ontology may also include the provision of an ontology that includes these types of references and is thus implemented as a distributed ontology. Since the input grammar may be used for analyzing files and/or second ontologies containing information for expanding the first ontology, the search and/or extraction rules are preferably generated and/or adapted as a function of the input grammar.

In this manner, the input grammar is used as an additional source of knowledge for automatically extracting new information from documents, files or ontologies that reside in databases of the system and/or on the Internet, for example, as the case may be, these optionally having different medial representations.

The first ontology may itself advantageously include linguistic information. In such a case, the method preferably provides that the search and/or extraction rules be generated and/or adapted as a function of this linguistic information stored in the first ontology. An adaptation of the search and/or extraction rules may, of course, also advantageously encompass a broadening of the search and/or extraction rules.

When adapting the search and/or extraction rules as a function of the input grammar, the first ontology is expanded as a function of the input grammar. Otherwise, as described above, the input grammar is advantageously expanded as a function of the first ontology. Thus, the first ontology and the input grammar are able to be expanded in a mutual, iterative process.

It is accordingly advantageously provided by the method to iteratively execute the expansion and/or correction of the input grammar as a function of the first ontology and of predefined expansion and/or correction rules, the adaptation of the search and/or extraction rules for expanding the first ontology as a function of the input grammar, and the expansion of the first ontology to include information obtained from files and/or second ontologies using the search and/or extraction rules.

Since the method is used for querying information stored in a structured format in a data processing system, in a controlled process via a dialog system, the method preferably provides for information to be queried by a user. The processing of a query for information by a user advantageously includes: registering user inputs via an input unit of the dialog system; ascertaining a user query by analyzing the registered user inputs; extracting queried information from the first ontology as a function of the ascertained user query; and outputting the extracted information via an output unit of the dialog system.

In addition, information may be advantageously entered and/or corrected in the first ontology by a user. For this purpose, the method preferably provides for user inputs to be registered via an input unit of the dialog system, for an entry query or correction query to be ascertained by analyzing the registered user inputs, and for the first ontology to be expanded or corrected as a function of the ascertained entry query or correction query.

Since user inputs are advantageously entered via natural language, the process of registering and/or analyzing user inputs advantageously includes executing at least one voice recognition, hands-free, echo compensation, speaker verification, speaker recognition, speaker classification, voice identification, speech synthesis and/or noise compensation function.

In the case of an expansion of the first ontology as the result of extraction of information from different sources of knowledge, conflicts may arise within the first ontology, the conflicts residing, for example, in missing or contradictory relationships among elements of the first ontology. However, the absence of an attribute value of an element of the first ontology may also be defined as a conflict, for example.

The method advantageously encompasses an automatic recognition of conflicts in the structure and/or among the instances of the first ontology, it being especially beneficial for a query to a user to be automatically generated in response to recognition of a conflict.

The purpose of the query directed to a user is to remove the conflicts detected within the first ontology, the decision being made, for example, via a user input in response to the query, as to which of two contradictory relationships between elements of the first ontology is the correct one and, accordingly, should be retained, and which should be removed from the first ontology.

To this end, the method preferably provides for at least one user to be automatically selected, for a communications link to a telecommunications terminal of the selected user to be automatically established through the dialog system, and for the generated query to be transmitted to the terminal. To remove the recognized conflict, the method advantageously provides for the selected user to enter and/or correct information in the first ontology in response to the transmitted query.

Thus, the method makes it possible for a user to query knowledge through the dialog system in order to enter into the first ontology, as is customary in interhuman communication when knowledge is exchanged.

To automatically select a user, a user identifier for at least one user and at least one assigned knowledge domain of an ontology are preferably stored in the dialog system.

To be able to selectively query one user from whom it may be expected that he/she has the knowledge necessary to remove a conflict, queriable users are advantageously assigned to predefined user classes, at least one knowledge domain of an ontology being assigned to at least one user class.

To be able to access a greater number of sources of knowledge and to make the stored information available to a greater number of users, the first ontology advantageously contains information in different languages. In this specific embodiment, the method advantageously provides for information contained in the first ontology to be translated from a first language into at least one second language using machine translation. It is especially preferred that information contained in the first ontology be synchronously maintained in a plurality of languages using machine translation. To that end, when expanding and/or correcting the first ontology, the information that has been included in the expansion and/or the corrected information is preferably automatically translated into the other respective languages supported by the first ontology. For example, German, English and French may be predefined as supported languages.

Thus, the described method makes it possible for input grammars, for example for voice recognition modules in a plurality of languages, for a multimodal and/or unimodal interaction with a dialog system, to be generated from ontologies. In addition, the method advantageously makes it possible for user inputs and/or information extracted from documents to be analyzed using these input grammars and/or supplementary grammars. It is preferable for documents to be analyzed in which elements of an ontology are described, the analysis making it possible for the ontologies to be supplemented and/or corrected by the described elements.

In this context, methods for searching for information in a plurality of media and/or methods for extracting information and/or for summarizing information in documents in different languages are very advantageously employed to search for terms which may be used to supplement the ontology system and, in turn, serve the purpose of supplementing the input grammars with the aid of the automatic grammar generation. In the same manner, new relationship definitions may also be found in an internal database or on the Internet with the aid of the grammar. In both cases, resources of a semantic network on the Internet may also be additionally accessed in which relationships to other elements may already be described in at least one element present in the ontology. The ontology that has been expanded by the described search methods, or at least a portion thereof, may now, in turn, be supplemented and/or corrected through multimodal or unimodal interaction with the user who is able to communicate both directly and/or via at least one network with the dialog system.

A data processing system according to the present invention for providing access to information stored in a structured format includes at least one memory in which information is stored in a structured format using a first ontology, a dialog system for user access to the stored information, and an arrangement for generating and/or adapting the input grammar of the dialog system as a function of the first ontology and of predefined generation and/or adaptation rules. The dialog system includes at least one input unit for registering user inputs, one input grammar for analyzing registered user inputs, one output grammar for generating output signals, and one output unit for outputting generated output signals.

In addition, the data processing system also advantageously includes an arrangement for providing an initial grammar as an input grammar that had been manually created by a system administrator, for example.

To expand the first ontology as a function of predefined search and/or extraction rules, the data processing system advantageously includes an arrangement for searching for and/or extracting information from files and/or second ontologies, it also being possible for the information to be linked by logic operations. Accordingly, the arrangement for searching for and/or extracting information is advantageously designed for expanding the first ontology by inserting at least one reference to at least one file and/or a second ontology and/or an element of a second ontology, it being possible for the second ontology, for its part, to also be provided as a distributed ontology. As already described above, a reference may include a file path, an Internet address or another address of a storage location, for example, and optionally additional parameters, it being possible for a selected portion of a second ontology, for example, to also be referenced by suitable parameters.

In addition, an arrangement is advantageously provided for generating and/or adapting the search and/or extraction rules as a function of the input grammar and/or as a function of linguistic information stored in the first ontology.

The dialog system is designed for recognizing informational queries from users. Accordingly, the data processing system preferably includes an arrangement for extracting information from the first ontology in response to a user query recognized by the dialog system. In addition, the information stored in the first ontology may be expanded and/or corrected by user inputs. Accordingly, the data processing system advantageously includes an arrangement for entering and/or correcting information in the first ontology in response to a user-posed entry or correction query recognized by the dialog system.

To analyze user inputs, the dialog system preferably includes at least one function module for executing a voice recognition, hands-free, echo compensation, speaker verification, speaker recognition, speaker classification, voice identification, speech synthesis and/or noise compensation function.

Since, as described above, when the first ontology is expanded, conflicts may arise within the ontology, an arrangement is also advantageously provided for automatically recognizing conflicts in the structure and/or among the instances of the first ontology.

One especially preferred specific embodiment provides for the data processing system to include an arrangement for automatically generating a query which is directed to a user when a conflict is recognized and whose purpose is to remove the recognized conflicts. Accordingly, the dialog system is preferably designed for automatically selecting at least one user, for establishing a communications link to a telecommunications terminal of the selected user, and for transmitting a generated query that is directed to the selected user, to his/her terminal.

To select a user suited for removing the conflict, the dialog system preferably includes a storage arrangement for storing a user identifier for at least one user and at least one assigned knowledge domain of an ontology. It is especially beneficial for the users, for whom a user identifier is stored, to be divided into user classes, at least one knowledge domain of an ontology being assigned to each of the user classes. Accordingly, for each user identifier, an assignment to at least one user class is preferably stored in the dialog system. In addition, an order of precedence may be assigned to the users allocated to one user class, for example, in order to establish the sequence for attempting transmission of a query to the users of the user class.

To be able to make relevant information available to a widest possible user circle, the first ontology advantageously includes information in different languages. To maintain synchronous information in the first ontology, even when it is expanded to include a plurality of languages, an arrangement for the machine translation of information contained in the first ontology from one first language into at least one second language are advantageously provided.

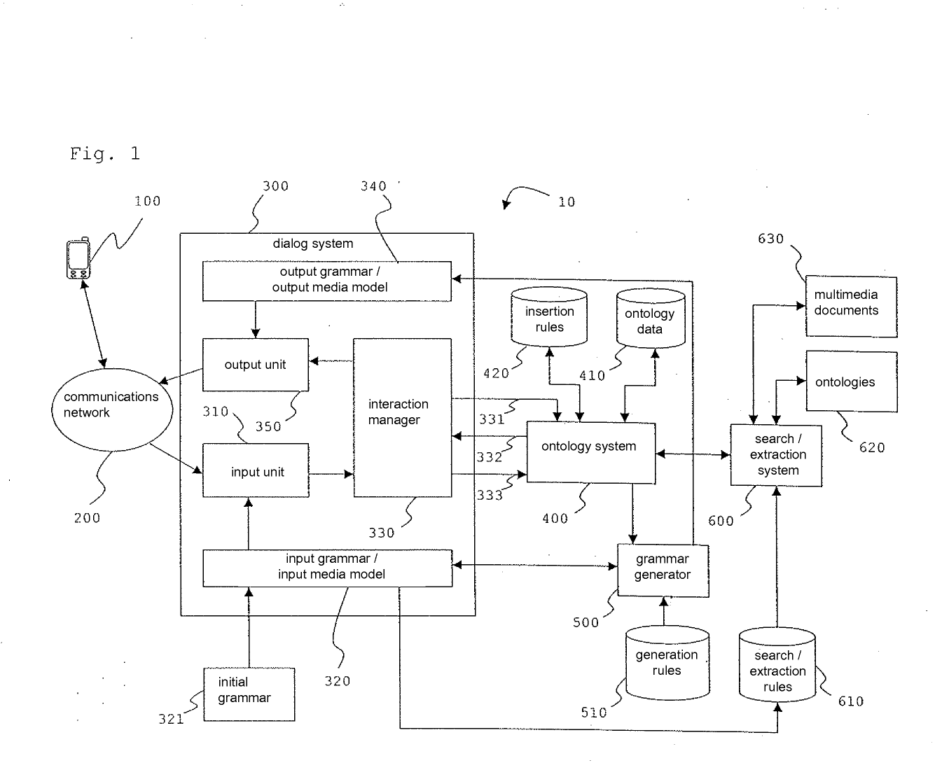

In the exemplary embodiment of a data processing system 10 illustrated in FIG. 1, a first design of an ontology that was created using administrative interfaces, for example, is stored in the ontology system denoted by 400. Alternatively or additionally, documents 630 are made available in, as the case may be, different medial representations and/or separate ontologies 620. Extraction methods are applied thereto using a search and extraction system 600 with the aid of predefined search and/or extraction rules 610, to obtain ontologies or partial ontologies in order to provide a first ontology design in ontology system 400. The thus obtained ontologies or partial ontologies may, in turn, be optionally revised via administrative interfaces.

In the illustrated exemplary embodiment, ontology contents stored in ontology system 400, ontology entries having assigned values, and ontology instances are stored in a separate database 410 to which ontology system 400 has access. Unless otherwise indicated, in the following, the term ontology denotes the ontology stored in ontology system 400 inclusive of the data stored in database 410.

Starting out from the assumption that, on the one hand, elements, inclusive of their relationships, are represented within an ontology, and, on the other hand, the mode of expression indicating how these ontology contents are accessed, is described by media models and/or input grammars, the inventors have discovered that the ontology contained in ontology system 400 also includes information from which an input grammar 320 may be generated.

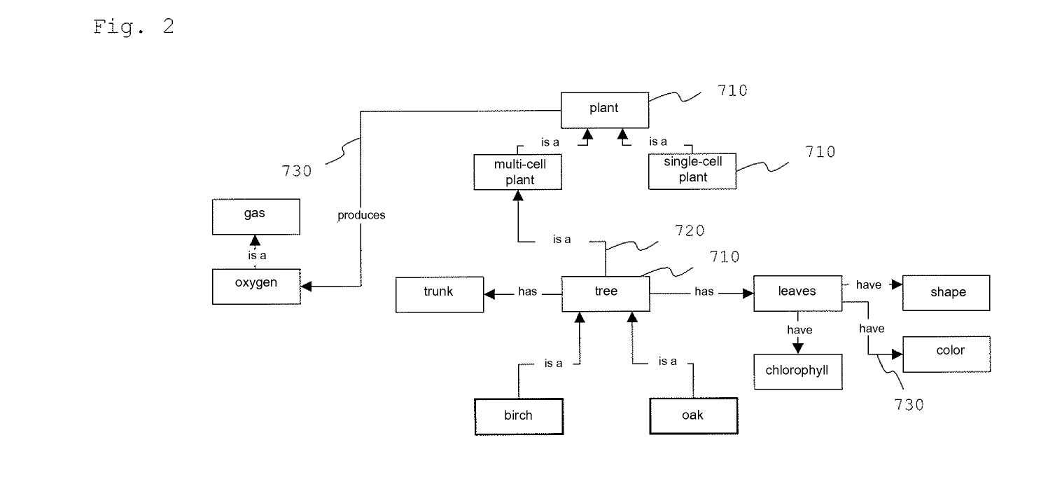

An example of a first ontology design is illustrated in FIG. 2. Accordingly, as elements of the ontology, designations or names of classes 710, such as “plant” or “tree” and/or instances 750 thereof, such as “oak tree” or “birch tree,” for example, and designations or names of relationships 720 and 730, such as “is a,” “produces” or “have” describe sequences of expressions which are likewise found, for example, in input grammar 320 of voice dialog system 300.

In this manner, once again with reference to FIG. 1, using a grammar generator 500 and in consideration of generation rules 510, simple grammars 320 and 340 may be generated to allow a user to communicate with a dialog system 300 used as an interface for querying, expanding and/or correcting an ontology for the user.

Since, in the illustrated exemplary embodiment, the dialog system may be designed for a multimedial and multimodal input and output, components 320 and 340 generally contain an input, respectively, output media model, which, however, are advantageously conceived as input, respectively, output grammars. In this context, a multimodal interaction signifies a communication with a system via a plurality of modes, for example, via voice and/or keyboard and/or stylus inputs.

To devise a more flexible design for these grammars, other linguistic information or properties may be included in the ontology of ontology system 400. This information may be extracted, for example, from dictionaries that are available locally and/or in the network or on the Internet, and/or to represent models, such as n-gram models, for example, having possible predecessors and successors of terms from the ontology that are extracted from documents 630 mentioned above or those similar thereto, or other ontologies 620. Thus, besides the originally included models that were created, in some instances, administratively in the form of an initial grammar 321 for general dialog steps, such as for responding to system questions “yes” or “no,” for example, subsequently to the generation process, the generated grammars and/or media models 320 and 340 are also provided with terms and formulations derived from the ontology.

Input grammar 320, which represents an input or speech model, may be designed, for example, as an EBNF grammar in text form and/or as a statistically based n-gram grammar. However, other grammar representations are likewise within the scope of the present invention.

Besides synonyms, the linguistic properties of elements in the ontology may also include, for example, antonyms of designations and/or relationships, parts of speech, gender, other ancillary words and/or substitute words, such as possible adverbs, prepositions or pronouns, for example. It is pointed out in this connection that synonyms do not constitute a linguistic property in the actual sense, and that the method described here preferably provides for linguistic properties stored in the ontology that go beyond the provision of synonyms. The word sequence for generating the grammar, for example, may be derived from the parts of speech, such as noun, verb or adjective; the gender may be used, for example, to determine the possible articles for the particular language. This information may also be extracted from documents 630 and/or other ontologies 620. Documents similar to documents 630 may also be searched for on the Internet, for example, and be used for extracting information.

Since the grammar, in particular input grammar 320 and parts thereof also constitute a model for a domain-specific language (also referred to in technical usage as “language model”), it is not only suited for relevant user inputs, but also for local and/or network documents in which this language is used to represent information. At this point, the thus generated grammar 320 may, in turn, be used for generating, supplementing and/or correcting the search and/or extraction rules 610.

Extraction rules 610, which, at this point, also include rules that were automatically derived from the grammar, respectively speech model 320, also form the basis for extracting information for the ontology from documents resulting from the automatic search for similar documents.

On the basis of the information that is inserted with the aid of search and extraction into the ontology of ontology system 400, at this point, grammar 320 and, subsequently thereto, the ontology may be supplemented again in 400 with the aid, as the case may be, of other derived search and/or extraction rules 610, until this iterative process, which may also be optionally subject to administrative intervention, is concluded.

Once a defined state of the ontology has been reached, first queries from the user, represented by his/her telecommunications terminal 100, for information derived from the ontology are possible via at least one channel of a communication network 200 suited for communication for the required media and via at least one dialog system 300.

To this end, using terminal 100, the user establishes a connection via communications network 200 to dialog system 300 and transmits a search query. Depending on the intended application, terminal 100 may be designed as a telephone, smartphone or PDA, for example, and optionally include a browser to be operated by the user. Accordingly, communications network 200 may be designed, for example, as a telephone network, cellular network, or as a WAN/LAN, and support fixed-line or wireless connections. The relevant user inputs are analyzed in dialog system 300 in input unit 310 with the aid of input grammar 320, it being possible for the analysis to include a semantic interpretation. The analyzed user inputs are directed by input unit 310 to an interaction manager 330, from where filtered-out search queries 333 are forwarded in a predefined format to ontology system 400.

Information 332 derived from the ontology by ontology system 400 as a function of the search query is transmitted back to interaction manager 330, which routes it to output unit 350. As a function of output grammar 340, output unit 350 generates the output data which are transmitted via communications network 200 to terminal 100 of the querying user.

Since formulations for defining possible relationships are also included in input grammar 320 due to the generation or expansion as a function of the ontology, the user also has the capability of entering new terms and/or formulations, to the extent that they are included in the media model, respectively input grammar 320, via the dialog using dialog system 300, along with corresponding relationships, into the ontology and thus has the capability of supplementing and/or correcting the ontology via the dialog. Subsequently to analysis by input unit 310, corresponding expansion or correction queries 331 are directed in a defined format by interaction manager 330 to ontology system 400.

The entries resulting from the automatic generation, expansion and/or correction of the ontology may also contain conflicts, such as open or contradictory relationships or missing attribute values, which, following automatic analysis of the ontology by ontology system 400, are communicated in a defined format to interaction manager 330 via a message 332 to this effect or are also ascertained by interaction manager 330 itself. From these structural conflicts, this may generate queries to user 100, for example in the form of a question, such as “what is red beech?”

Possible responses from the user in the context of the knowledge domain represented in the ontology are analyzed, in turn, with the aid of input grammar 320, and filtered-out information 331 is entered into the ontology, optionally in consideration of defined insertion rules 420. To resolve conflicts in the ontology, dialog system 300 itself may also become active and establish contact with users, and pose questions derived from the conflicts. To this end, the users may be taken from a list stored in dialog system 300 that includes corresponding user identifiers. As a user identifier, at least one of the information items, call number, CLI (calling line identification), HLR (home location register), IP address, terminal identifier, name, initials, pseudonym or alias, for example, may be stored.

To verify the user, methods for speaker verification or speaker recognition and/or speaker classification and/or, given a terminal equipped accordingly, face recognition and/or fingerprint recognition and/or other biometric methods may be used.

Together with the user identifiers, the desired languages and/or modes for communicating between user 100 and dialog system 300 and/or data may also be stored in a personalized knowledge domain-based process. These data are then used, for example, for selecting the grammar and/or the media model for the desired language and/or for selecting individual grammars and/or media models. The knowledge domains may be used for establishing contact with the user only in the case of conflicts arising from a specific knowledge domain, for example the knowledge domain relating to “leaves.”

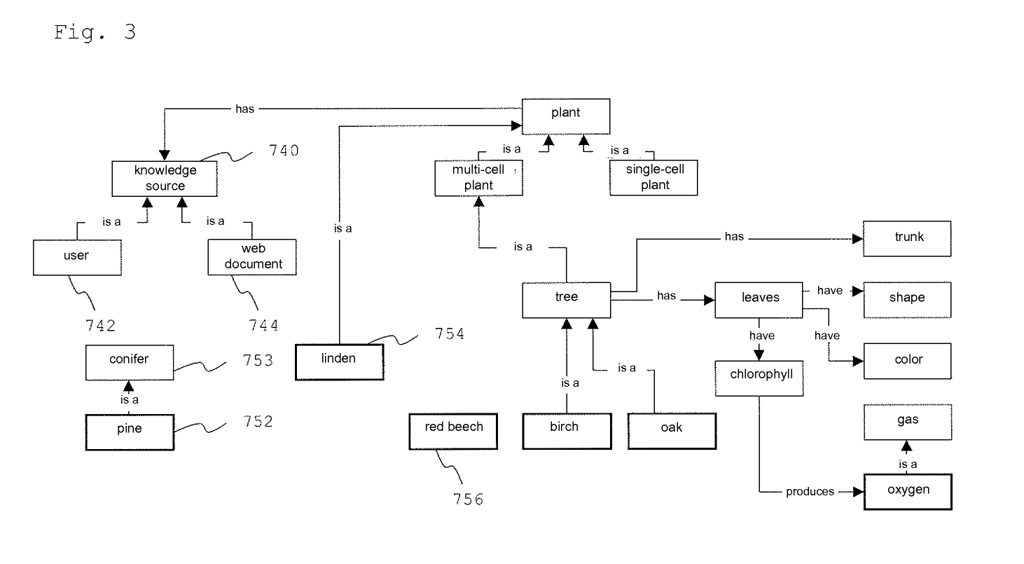

As illustrated in FIG. 3, these data may also be directly allocated to individual elements of the ontology to define knowledge sources 740 for individual sub-areas or subdomains. If conflicts arise in the area assigned to one or more users 742, then only these users are actively contacted by the system. Or, if a connection is established from the user side, they are queried by the system while the user identifier is subject to analysis by dialog system 300. Besides people as users 742, addresses of documents 744 may also be indicated, for example as links, as well as other ontologies as knowledge sources 740 for domains and subdomains in the ontology. These documents that have been selected, for example, in a process that ranks them in terms of similarity to a reference document, for example the existing ontology, may then again be included in the extraction for supplementing the ontology, for example in each iteration step of the iteration process described above.

Therefore, as at least one knowledge domain in at least one ontology may be assigned to at least one user, these knowledge domains may also be assigned to specific user classes without knowledge of the individual. Using speaker classification methods, it is possible to ascertain, for example, which language the user speaks, which is important, for example, in terms of selecting the correct language-specific grammar and/or the media models. In addition, age, gender, emotional state and other speaker characteristics may be ascertained, for example. Thus, at least one knowledge domain of at least one ontology may also be assigned to specific speaker classes when selecting the people to be queried by the ontology system.

Thus, these queries may be posed by the system in a process that is selective in terms of user classes for at least one assigned knowledge domain, both following the establishment of a connection by the people in question, following use of the speaker classification, and may also be actively initiated by the system by establishing at least one connection, given knowledge of the users assigned to at least one user class.

Grammars 320 and 340 are advantageously provided for each of the languages desired for a multilingual dialog system 300. Accordingly, the linguistic information may also be provided in a plurality of languages for elements of the ontology, different attribute types also being optionally defined for different languages. For example, for languages in which it is irrelevant, the gender may also be omitted. In addition, for multilingual systems, models, such as n-gram models, for example, may also be optionally provided in the various languages for the corresponding elements. The information, data and/or models may be directly included in the ontology. However, reference thereto may also be made from the ontology.

Subsequently to or already during integration of the user knowledge via dialog system 300 into the ontology managed by ontology system 900, the iterative process described above is carried out dynamically in order to include knowledge from other documents, while allowing for dynamic adaptation of the grammar, respectively of the media models, as well as for adaptation of linguistic information for elements of the ontology, which, still during the dialog with the user, may result in new ontology conflicts and thus in the generation of further queries to the user by the system. In this manner, a consistent continuation of the dialog may be dynamically generated until a state of saturation sets in, which is evident from the absence of ontology conflicts and the absence of additional user inputs. In the process, in response to initiation by the described ontology conflicts, the dialog may be driven by dialog system 300, and, in response to initiation by at least one appropriate interaction, it may be driven by the user.

Examples of ontologies are illustrated in FIGS. 2, 3 and 4. In the figures, bottom-up relationships, such as relationship 720, typically describe the relationship of a subclass or of a subconcepts i.e., the class located at a higher level is also higher up in the class hierarchy described by the ontology. Lateral or top-down relationships, such as relationship 730, for example, typically describe attributes of classes.

A conceptual design process was used to create the ontology design illustrated in FIG. 2, for example, that describes trees. Also, at least one input grammar 320, which is used for analyzing user inputs, for example through the use of voice recognition, and/or for analyzing documents, may also be created in a preliminary design process in such a way that modes of expression for relationships, such as “<element1> . . . is an . . . <element2>”, “<element1> . . . is an . . . <element2>”, “<element1> . . . has/have <element1>” and/or “<element1> . . . produces <element1>”, are represented therein, <element1> and <element2> each denoting types of elements that may also be included in the ontology.

Upon completion of the conceptual design for the ontology within ontology system 400, a process is automatically initiated, which, from the element terms included in the ontology and the relationship terms that may already be included, supplements the designed grammar 320 in accordance with generation rules 510 implemented in a software or explicitly present in a database.

Subsequently thereto, a process may preferably be automatically initiated which searches for directly available databases and/or on the Internet for documents 630 and/or other ontologies 620 in which similar terms and relationships are already described. For example, in a document found in which the terms “plant,” “tree” and “birch” occur and/or whose relationships are described, the sentence, “a linden tree is a plant” may also be included. This sentence describes the relationship “is a” between a “linden tree” and a “plant” as a class or concept relationship that may also occur as a different grammatical form of expression defined in the first design phase of grammar 320 or generated from the designed ontology using grammar generator 500. Since the word “plant” has already been defined once in the ontology, it was also carried over into input grammar 320. Since, at this point, the word sequence “the linden tree is a plant” corresponds to the grammar “<element1> . . . is an . . . <element2>,” an automatic analysis carried out with the aid of grammar 320 yields a high probability that the word “linden tree” 754 is included with the described relationship in the ontology and, as the case may be, in consideration of corresponding rules 510 implemented in the generation process, may be entered into input grammar 320 in order to generate the same.

In this manner, the ontology illustrated in FIG. 2, which has been generated as a first design, may be expanded and/or corrected in order to arrive at the ontology illustrated in FIG. 3. Besides insertion of the element “linden tree” 754 and the corresponding relationship to the element “plant,” other expansions of the ontology are also shown in FIG. 3. Thus, the elements “pine tree” 752 and “coniferous tree” 753, along with the relationship “is a” that defines them, are inserted into the ontology. The relationship “produces” between the element “plant” and the element “oxygen” was removed, and inserted instead between the elements “chlorophyll” and “oxygen.”

In addition, the ontology illustrated in FIG. 3 includes the information that knowledge sources are available for the element “plant,” expressed by the relationship “has” between the elements “plant” and “knowledge source” 740. In addition, the elements “user” 742 and “web document” 744 are entered into the ontology as possible knowledge sources, along with the corresponding relationships. Added finally to the ontology is the element “red beech,” which, however, does not have any relationships to other elements of the ontology.

At this point, similar documents 630 found may likewise be utilized for training or adapting the media model, provided, for example, as a speech model, of a statistically based media recognition device, designed, for example, as speech or dictation recognition, so that not only is the knowledge base expanded within the domains found, but the media model is as well.

At this point, in an analysis process employing grammar 320, it is likewise possible to analyze user inputs for expanding the knowledge base existing in the form of an ontology, including corresponding instances stored, for example, in a database 410. For example, if the word “linden” is already present in the knowledge base represented by the ontology and, subsequently to automatic grammar generation by grammar generator 500, is also already present in grammar 320, and, for example, relationships to other elements are lacking, then, at this point, the ontology may be supplemented by the relationship (not shown) between “linden” and “tree” by a user speaking the sentence “the linden is a tree” using a terminal 100, by transmission to dialog system 300, by recognition by input unit 310 and analysis using input grammar 320, and by routing of the result by interaction manager 330 to ontology system 400. In this manner, the knowledge stored in the knowledge base represented by the ontology may be expanded by the input of a user.

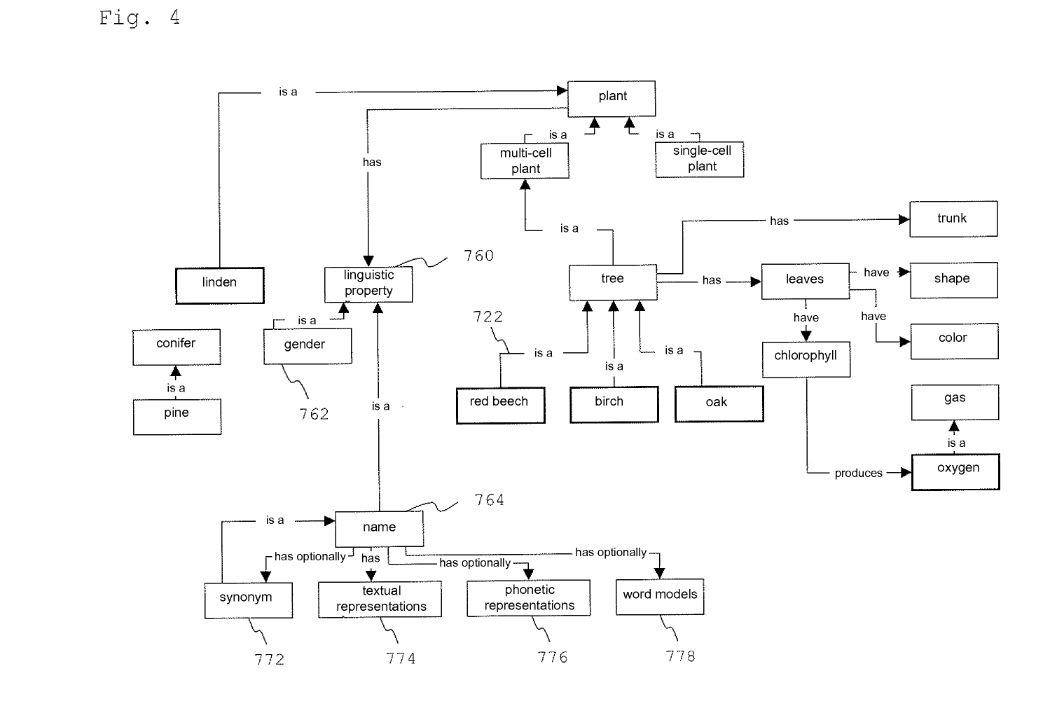

Data processing system 10 has an arrangement for ascertaining conflicts within the ontology which reside in ontology system 400, for example. This arrangement is designed for determining, for example, the absence of relationships to an element. If, at this point, for example, the element “red beech” 756 illustrated in FIG. 3 does not have a relationship with other elements, then ontology system 400 may forward a conflict message 332 to this effect to interaction manager 330, which, via output unit 350 with the aid of output grammar 340, prompts a spoken query to be generated to the user, for example in the form of the question, “what is red beech?” In response to the spoken response, “the red beech is a tree,” the ontology may, at this point, be supplemented by corresponding relationship 722, as illustrated in FIG. 4.

If, because of inarticulate pronunciation or background noise, a plurality of N-best results from the recognition device are possible, then a confirmation dialog with the user initiated by interaction manager 330 may clarify which of the recognized terms was meant.

Since, following analysis of the sentence, “the red beech is a tree” and corresponding entry into the ontology, it is clear at this point that “red beech” describes a tree with leaves, but the attribute value for the color of the leaves is missing, for example, a question about the color may be posed. At this point, the user may respond verbally using the sentence, “the color of the leaves is red,” that is to be analyzed with the aid of grammar 320 or, for example, also use a stylus to touch a red color field on a touch screen of his/her terminal 100.

The ontology illustrated in FIG. 4 includes linguistic properties 760, for example for the class “plant” located at the highest level in the hierarchy. In the illustrated exemplary embodiment, these include “gender” 762, as well as for “name” 764, for example the elements “synonym” 772, “textual representations” 774, “phonetic representations” 776 and “word models” 778.

By expanding the elements by attributes which constitute phonetic representations or derived word models in other representations, the inclusion of previously unknown elements from spoken utterances as well, may be rendered possible. The spoken input of the sentence, “the elm is a tree” may not yet be directly analyzed due to the absence of the word “elm” in grammar 320. To detect a missing expression when working with a deterministic grammar, for example, a blank symbol is needed, which, upon analysis of the word sequence by the grammar interpreter, may prompt a suitably equipped recognition device to send a phoneme sequence recognized with a certain probability in an agreed-upon format to interaction manager 330. To this end, however, the recognition device must be subject to stringent requirements with regard to filtering the interfering signal. At this point, below the representation of the tree designation obtained from interaction manager 330, ontology system 400 may create a corresponding instance in database 410 that, in fact, does not include any name in textual form, however, whose attribute of phonetic representations includes recognized phoneme sequences (among these are, for example, the phoneme sequences “elm” and “palm”). At this point, from dictionaries that are available locally and or on the Internet, possible textual representations may be found, among which a selection may be made in the dialog between user 100 and dialog system 300, thereby allowing the applicable textual representation to be entered into the ontology.

The linking of attributes representing linguistic properties to elements of an ontology allow this ontology to be considered in a first step as a media or speech model, even if as an initially rudimentary. This means that at least portions of the grammar and/or the entire grammar, as well as the media model or the output model may be represented in the ontology. If, for example, the gender of a term is described by a preceding article, which may likewise be described in at least one attribute of an ontology element, then it may be analyzed by way of the voice input and be entered by ontology system 400. Thus, the gender of the term “red beech” may be inferred from the entry “the red beech is a tree.” At this point, in order to further develop knowledge represented in an ontology in multiple-language dialog systems 300 by the users, as well as to output in the various required languages, the properties for different languages may be stored in different attributes for linguistic properties. Thus, once combined with a linguistic ontology annotated with corresponding attributes, various language-specific, modified BNF grammars (Backus-Naur form) would only need to partially describe general language properties using a reduced set of terminal symbols. This requires access to the ontology by the requisite interpreter, for example, for the media recognition designed as voice recognition for the media model or by the grammar interpreter. Thus, this also or exclusively becomes an ontology interpreter. In this case, at least portions of the speech model are managed by ontology system 400 itself and are generated within ontology system 400.

The described method makes it possible for administrator, expert and user knowledge to be mutually integrated, as well as knowledge from documents, in order to generate, correct and/or supplement ontologies and the grammars necessary for exchanging information between users and the ontology system and/or media models, such as speech models, for example.

Using the method, it is possible to obtain extraction rules for extracting ontologies from documents we well as from the models and/or grammars originally only provided for the user dialog.

By integrating linguistic information and dynamically adapting the same during the described iterative processes, the outlay required for managing a separate grammar may be advantageously eliminated. If this information is available for a plurality of languages, then operation of the system is also possible for users who speak different languages.

1-39. (canceled)

40. A method for the controlled querying of information stored in a structured format in a data processing system using a dialog system, the method comprising:
providing at least one first ontology con-figured to store information in a structured format; and
providing at least one input grammar in the dialog system configured to analyze user inputs as a function of the at least one first ontology.

41. The method as recited in claim 40, wherein the providing the at least one input grammar includes generating the at least one input grammar from the at least one first ontology as a function of predefined generation rules.

42. The method as recited in claim 40, wherein the providing the at least one input grammar includes:
providing a predefined initial grammar as the input grammar; and
at least one of expanding and correcting the initial grammar as a function of the at least one first ontology and of at least one of predefined expansion and correction rules.

43. The method as recited in claim 40, wherein the at least one input grammar includes a model for describing a sequence in which a media recognition device expects inputs.

44. The method as recited in claim 40, further comprising expanding the at least one first ontology to include information obtained from at least one of files and second ontologies using at least one of search and extraction rules.

45. The method as recited in claim 44, further comprising at least one of generating and adapting at least one of the search and extraction rules as a function of the at least one input grammar.

46. The method as recited in claim 44, further comprising at least one of generating and adapting at least one of the search and extraction riles as a function of linguistic information stored in the at least one first ontology.

47. The method as recited in claim 44, wherein the expanding the first ontology includes inserting at least one reference to at least one of at least one file, to a second ontology and to an element of a second ontology into the at least one first ontology.

48. The method as recited in claim 40, further comprising:
at least one of expanding and correcting the at least one input grammar as a function of the at least one first ontology and of at least one of predefined expansion and correction rules;
at least one of adapting and expanding at least one of the search and extraction rules; and
expanding iteratively the at least one first ontology to include information obtained from at least one of files and second ontologies using at least one of the search and: extraction rules.

49. The method as recited in claim 40, further comprising querying for information by a user.

50. The method as recited in claim 49, further comprising:
registering the user inputs via an input unit of the dialog system;
ascertaining a user query by analyzing the registered user inputs;
extracting queried information from the at least one first ontology as a function of the ascertained user query; and
outputting the extracted information via an output unit of the dialog system.

51. The method as recited in claim 40, further comprising at least one of entering and correcting, by a user, information in the at least one first ontology.

52. The method as recited in claim 51, further comprising:
registering the user inputs via an input unit of the dialog system;
ascertaining an entry or correction query by analyzing the registered user inputs; and
expanding or correcting the at least one first ontology as a function of the ascertained entry or correction query.

53. The method as recited in claim 50, wherein the at least one of the registering and analyzing of user inputs includes execution of at least one of a voice recognition, a hands-free, a echo compensation, a speaker verification, a speaker recognition, a speaker classification, a voice identification, a speech synthesis and a noise compensation function.

54. The method as recited in claim 40, wherein the at least one first ontology includes a hierarchical class structure having at least one of classes, instances of classes, relationships among classes and attributes.

55. The method as recited in claim 54, further comprising automatically recognizing conflicts in at least one of the stricture and among instances of the first ontology.

56. The method as recited in claim 55, further comprising automatically generating a query to the user in response to recognition of a conflict.

57. The method as recited in claim 56, further comprising:
automatically selecting at least one user;
automatically establishing, through the dialogue system a communications link to a telecommunications terminal of the selected user; and
transmitting the generated query to the terminal.

58. The method as recited in claim 57, further comprising at least one of entering and correcting information in the at least one first ontology by the selected user in response to the transmitted query in, order to remove the recognized conflict.

59. The method as recited in claim 57, further comprising automatically selecting a user, a user identifier for at least one user and at least one assigned knowledge domain of at least one ontology stored in the dialog system.

60. The method as recited in claim 59, further comprising assigning queriable users to predefined user classes, at least one knowledge domain of at least one ontology assigned to at least one user class.

61. The method as recited in claim 40, wherein the at least one first ontology includes information in different languages.

62. The method as recited in claim 40, further comprising translating, using machine translation, information contained in the at least one first ontology from a first language into at least one second language.

63. The method as recited in claim 62, further comprising at least one of expanding and correcting the at least one first ontology, the information included in different languages in the at least one first ontology automatically synchronously maintained using machine translation.

64. A data processing system for providing access to information stored in a structured format, comprising:
at least one memory configured to store information in a structured format using at least one first ontology;
a dialog system configured to provide user access to the stored information, the dialog system including: an input unit configured to register user inputs; an input grammar con-figured to analyze registered user inputs; an output grammar configured to generate output signals; and an output unit configured to output generated output signals; and
an arrangement configured to at least one of generate and adapt the input grammar of the dialog system as a function of the at least one first ontology and at least one of predefined generation and adaptation miles.

65. The data processing system as recited in claim 64, further comprising an arrangement configured to provide an initial grammar as the input grammar.

66. The data processing system as recited in claim 64, further comprising an arrangement configured to at least one of search for and extract information from at least one of files and at least one second ontologies to expand the at least one first ontology as a function of at least one of predefined search and extraction rules.

67. The data processing system as recited in claim 66, further comprising am arrangement configured to at least one of generate and adapt the at least one search and extraction rules as at least one of a function of the input grammar and a function of linguistic information stored in the at least one first ontology.

68. The data processing system as recited in claim 66, further comprising an arrangement configured to at least one of searching, for and extract information designed for inserting references to at least one of at least one file, a second ontology and an element of a second ontology into the at least one first ontology.

69. The data processing system as recited in claim 64, further comprising an arrangement configured to extract: information from the at least one first ontology in response to a user query recognized by the dialog system.

70. The data processing system as recited in claim 64, further comprising all arrangement configured to at least one of enter and correct information in the at least one first ontology in response to a user-posed entry or correction query recognized by the dialog system.

71. The data processing system as recited in claim 64, wherein the dialog system includes at least one of a function module for executing a voice recognition, a hands-free, a echo compensation, a speaker verification, a speaker recognition, a speaker classification, a voice identification, a speech synthesis and a noise compensation function.

72. The data processing system as recited in claim 64, further comprising an arrangement configured to automatically recognize conflicts in at least one of the structured format and among the instances of the at least one first ontology.

73. The data processing system as recited in claim 72, further comprising an arrangement configured to automatically generate a query directed to the user when a conflict is recognized in at least one of the structured format and among the instances of the at least one first ontology.

74. The data processing system as recited in claim 73, wherein the dialog system is configured to: automatically select at least one user, establish a communications link to a telecommunications terminal of the selected user; and transmit to the terminal a generated query that is directed to the selected user.

75. The data processing system as recited in claim 74, wherein the dialog system includes a storage arrangement configured to store a user identifier and at least one assigned knowledge domain of at least one ontology for at least one user.

76. The data processing system as recited in claim 75, wherein the user identifier is assigned to at least one user class and at least one knowledge domain of at least one ontology is assigned to at least one user class.

77. The data processing system as recited in claim 64, wherein the at least one, first ontology includes information in different languages.

78. The data processing system as recited in claim 77, further comprising an arrangement configured for machine translation, from a first language into at least one second language, of information contained in the at least one first ontology.
